(19) United States
(12) Patent Application Publication
(10) Pub. No.: US 2025/0334866 A1
(43) Pub. Date: Oct. 30, 2025

(54) ACTUATING DEVICE AND PROJECTOR

(71) Applicant: Coretronic Corporation, Hsin-Chu (TW)

(72) Inventors: Wei-Hao Chen, Hsin-Chu (TW); Pen-Ning Kuo, Hsin-Chu (TW)

(73) Assignee: Coretronic Corporation, Hsin-Chu (TW)

(21) Appl. No.: 19/190,752

(22) Filed: Apr. 27, 2025

(30) Foreign Application Priority Data
Apr. 30, 2024 (CN) 202410538747.6

(51) Int. Cl. G03B 21/14; H01F 7/08

(52) U.S. Cl. CPC G03B 21/14; H01F 7/081

(57) ABSTRACT

An actuating device include a base, a frame body, two first shaft portions, an optical element, a frame body driving assembly, and a frame body sensing module. The two first shaft portions extend along a first axis. Each first shaft portion is located between the frame body and the base. The optical element is disposed in an opening of the frame body. The frame body driving assembly drives the frame body to swing about the two first shaft portions as rotating axes and includes a first coil and a first magnetic element disposed on one of the two first side walls and is located between the first coil and the frame body. The frame body sensing module is connected to the base and includes a frame body sensor disposed adjacent to the first magnetic element to sense an amount of change in magnetic field strength of the first magnetic element.

### CROSS-REFERENCE TO RELATED APPLICATION

This application claims the priority benefit of China application serial no. 202410538747.6 filed on Apr. 30, 2024. The entirety of the above-mentioned patent application is hereby incorporated by reference herein and made a part of this specification.

### BACKGROUND

### Technical Field

The disclosure relates to an optical device, and particularly relates to an actuating device and a projector using the actuating device.

### Description of Related Art

In the technical field of projectors, conventional technology may improve the image resolution of a projector through the pixel shift technology. However, the image pixel displacement generated by an actuator during pixel shift may vary due to tolerances of electronic or mechanical components as well as environmental factors. When the variation amount affects the imaging quality, correction is required. However, a currently-available driving device that drives the actuator to perform pixel shift has an open loop design, which means that it has been calibrated before leaving the manufacturing factory, and once it leaves the manufacturing factory, image pixel displacement monitoring and compensation can no longer to be performed. Therefore, how to monitor the image pixel displacement is a main technical problem to be solved.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The disclosure provides an actuating device capable of indirectly monitoring image pixel displacement.

The disclosure further provides a projector including the above-mentioned actuating device and capable of monitoring and optimizing image pixel displacement, to improve a resolution of a projected image.

Additional aspects and advantages of the present disclosure will be set forth in the description of the techniques disclosed in the present disclosure.

In order to achieve one or a portion of or all of the objects or other objects, an embodiment of the disclosure provides an actuating device configured to receive an image beam. The actuating device includes a base, a frame body, two first shaft portions, an optical element, a frame body driving assembly, and a frame body sensing module. The frame body is swingably connected to the base. The frame body includes an opening. The opening is located between the two first shaft portions. The two first shaft portions extend along a first axis and are respectively connected to two opposite sides of the frame body. Each of the two first shaft portions is located between the frame body and the base. The frame body further has two first side walls located on a second axis and opposite to each other. The first axis is perpendicular to the second axis. The optical element is disposed in the opening of the frame body. The frame body driving assembly is configured to drive the frame body to swing about the two first shaft portions as rotating axes, so that the frame body drives the optical element to swing back and forth relative to the base. The frame body driving assembly includes a first coil and a first magnetic element. The first magnetic element is disposed on one of the two first side walls of the frame body and is located between the first coil and the frame body. The first coil corresponds to the first magnetic element and is disposed on the base. The frame body sensing module is connected to the base and includes a frame body sensor. The frame body sensor is disposed adjacent to the first magnetic element to sense an amount of change in magnetic field strength of the first magnetic element.

In order to achieve one or a portion of or all of the objects or other objects, an embodiment of the disclosure provides a projector including an illumination system, a light valve, a projection lens, and an actuating device. The illumination system is configured to provide an illumination beam. The light valve is configured to convert the illumination beam into an image beam. The projection lens is configured to project the image beam out of the projector. The actuating device (actuator) is disposed between the light valve and the projection lens to receive the image beam. The actuating device includes a base, a frame body, two first shaft portions, an optical element, a frame body driving assembly and a frame body sensing module. The frame body is swingably connected to the base. The frame body includes an opening. The opening is located between the two first shaft portions. The two first shaft portions extend along a first axis and are respectively connected to two opposite sides of the frame body. Each of the two first shaft portions is located between the frame body and the base. The frame body further has two first side walls located on a second axis and opposite to each other. The first axis is perpendicular to the second axis. The optical element is disposed in the opening of the frame body. The frame body driving assembly is configured to drive the frame body to swing about the two first shaft portions as rotating axes, so that the frame body drives the optical element to swing back and forth relative to the base. The frame body driving assembly includes a first coil and a first magnetic element. The first magnetic element is disposed on one of the two first side walls of the frame body and is located between the first coil and the frame body. The first coil corresponds to the first magnetic element and is disposed on the base. The frame body sensing module is connected to the base and includes a frame body sensor. The frame body sensor is disposed adjacent to the first magnetic element to sense an amount of change in magnetic field strength of the first magnetic element.

Based on the above description, the embodiments of the disclosure have at least one of following advantages or effects. In the design of the actuating device of the disclosure, the frame body driving assembly includes the first coil and the first magnetic element, and the frame body sensor of the frame body sensing module is disposed adjacent to the first magnetic element to sense the amount of change in magnetic field strength of the first magnetic element. Namely, the frame body sensor may sense the amount of change in magnetic field strength of the first magnetic element of the frame body driving assembly to indirectly monitor an image pixel displacement, and feedback a signal corresponding to the amount of change in magnetic field strength to the controller to adjust a digital waveform and gain data (GAIN), so as to optimize the displacement of pixel shift (such as reducing error/variation amount) by using a control method of a closed loop system.

Other objectives, features and advantages of the present disclosure will be further understood from the further technological features disclosed by the embodiments of the present disclosure wherein there are shown and described preferred embodiments of this disclosure, simply by way of illustration of modes best suited to carry out the disclosure.

### BRIEF DESCRIPTION OF THE DRAWINGS

FIG. 1 is a schematic diagram of a projector according to an embodiment of the disclosure.

FIG. 2A is a schematic top perspective view of an actuating device in FIG. 1.

FIG. 2B is a schematic three-dimensional exploded view of FIG. 2A.

FIG. 2C is a schematic cross-sectional view along a line I-I of FIG. 2A.

FIG. 2D is a top view of an actuating device added with a driving assembly and a sensing module based on FIG. 2A.

FIG. 3A is a schematic diagram of an actuating device according to an embodiment of the disclosure.

FIG. 3B is a schematic diagram of an actuating device according to another embodiment of the disclosure.

FIG. 4A is a top perspective view of an actuating device according to another embodiment of the disclosure.

FIG. 4B is a schematic three-dimensional exploded view of FIG. 4A.

FIG. 4C is a schematic three-dimensional view of FIG. 4A from another viewing angle.

FIG. 4D is a schematic cross-sectional view along a line II-II of FIG. 4A.

FIG. 4E is a top view of an actuating device added with a driving assembly and a sensing module based on FIG. 4A.

FIG. 5 is a schematic three-dimensional view of a sensing module according to an embodiment of the disclosure.

FIG. 6A is a schematic top perspective view of an actuating device according to another embodiment of the disclosure.

FIG. 6B is a schematic three-dimensional view of FIG. 6A from another viewing angle.

FIG. 6C is a schematic cross-sectional view along a line III-III of FIG. 6A.

FIG. 6D is a schematic image of magnetic field distribution simulation of a driving assembly and a sensing module of FIG. 6A.

FIG. 6E is a schematic curve graph of displacement and magnetic flux of the tested sensing module in FIG. 6D.

FIG. 7 is a schematic diagram of an actuating device according to another embodiment of the disclosure.

FIG. 8A is a schematic top perspective view of an actuating device according to another embodiment of the disclosure.

FIG. 8B is a schematic three-dimensional view of FIG. 8A from another viewing angle.

FIG. 8C is a schematic cross-sectional view along a line IV-IV of FIG. 8A.

FIG. 8D is a schematic cross-sectional view along a line V-V of FIG. 8A.

FIG. 8E is a schematic image of magnetic field distribution simulation of a driving assembly and a sensing module of FIG. 8A.

FIG. 9A is a schematic top perspective view of an actuating device according to another embodiment of the disclosure.

FIG. 9B is a schematic three-dimensional view of FIG. 9A from another viewing angle.

FIG. 9C is a schematic cross-sectional view along a line VI-VI of FIG. 9A.

FIG. 9D is a schematic cross-sectional view along a line VII-VII of FIG. 9A.

FIG. 9E is a schematic image of magnetic field distribution simulation of a driving assembly and a sensing module of FIG. 9A.

FIG. 9F is a schematic curve graph of displacement and magnetic flux of the tested sensing module in FIG. 9E.

### DESCRIPTION OF THE EMBODIMENTS

In the following detailed description of the preferred embodiments, reference is made to the accompanying drawings which form a part hereof, and in which are shown by way of illustration specific embodiments in which the disclosure may be practiced. In this regard, directional terminology, such as “top,” “bottom,” “front,” “back,” etc., is used with reference to the orientation of the Figure(s) being described. The components of the present disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present disclosure. Also, it is to be understood that the phraseology and terminology used herein are for the purpose of description and should not be regarded as limiting. The use of “including,” “comprising,” or “having” and variation amounts thereof herein is meant to encompass the items listed thereafter and equivalents thereof as well as additional items. Unless limited otherwise, the terms “connected,” “coupled,” and “mounted” and variation amounts thereof herein are used broadly and encompass direct and indirect connections, couplings, and mountings. Similarly, the terms “facing,” “faces” and variation amounts thereof herein are used broadly and encompass direct and indirect facing, and “adjacent to” and variation amounts thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

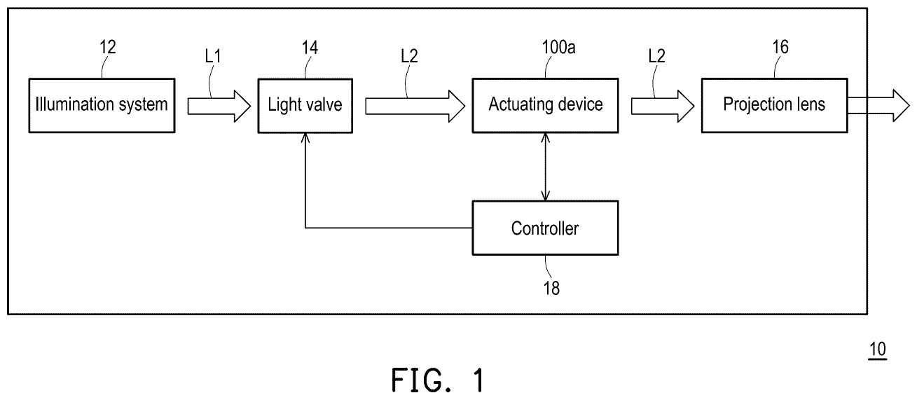

FIG. 1 is a schematic diagram of a projector according to an embodiment of the disclosure. Referring to FIG. 1 first, in the embodiment, a projector 10 includes an illumination system 12, a light valve 14, a projection lens 16, and an actuating device 100a. The illumination system 12 is configured to provide an illumination beam L1. The light valve 14 is configured to convert the illumination beam L1 into an image beam L2. The projection lens 16 is configured to project the image beam L2 to the outside of the projector 10. The actuating device 100a is disposed between the light valve 14 and the projection lens 16 for receiving the image beam L2. The projector 10 further includes a controller 18 coupled to the actuating device 100a and the light valve 14. The controller 18 may output a driving signal to drive the actuating device 100a.

In the embodiment the illumination system 12 used has a light-emitting element, such as a laser diode (LD), such as a laser diode bank. Any light source that meets a volume requirement in actual design may be used as an implementation, which is not limited by the disclosure. The illumination system 12 further includes, for example, one or a plurality of optical elements such as a lens, a dichroic mirror, a reflector, a light uniformizing element (such as a fly-eye lens or an integrating rod), a filter wheel, a phosphor wheel, or/and a light diffuser, etc., for generating color lights of different wavebands as the source of the illumination beams L1. The light valve 14 is, for example, a reflective light modulator such as a liquid crystal on silicon panel (LCoS panel) or a digital micro-mirror device (DMD). In an embodiment, the light valve 14 may also be a transmissive light modulator, such as a transparent liquid crystal panel, an electro-optical modulator), a magneto-optic modulator, or an acousto-optic modulator (AOM), etc. The embodiment does not limit the type and pattern of the light valve 14. Regarding detailed steps and implementation method of the light valve 14 for modulating the illumination beam L1 into the image beam L2, sufficient teachings, suggestions and implementation instructions may be learned from common knowledge of the technical field, and details thereof are not repeated. The projection lens 16 includes, for example, a combination of one or more optical lenses with refractive power, such as various combinations of non-planar lenses such as a biconcave lens, a biconvex lens, a concavo-convex lens, a convexo-concave lens, a plano-convex lens, a plano-concave lens, etc. In an embodiment, the projection lens 16 may also include a planar optical lens to project the image beam L2 from the light valve 14 out of the projector 10 in a reflective or transmissive manner. Here, the embodiment does not limit the type and pattern of the projection lens 16. It should be noted that axial directions of X, Y, and Z axes are drawn in each diagram below, so that the viewing angle of each diagram may be clearly known.

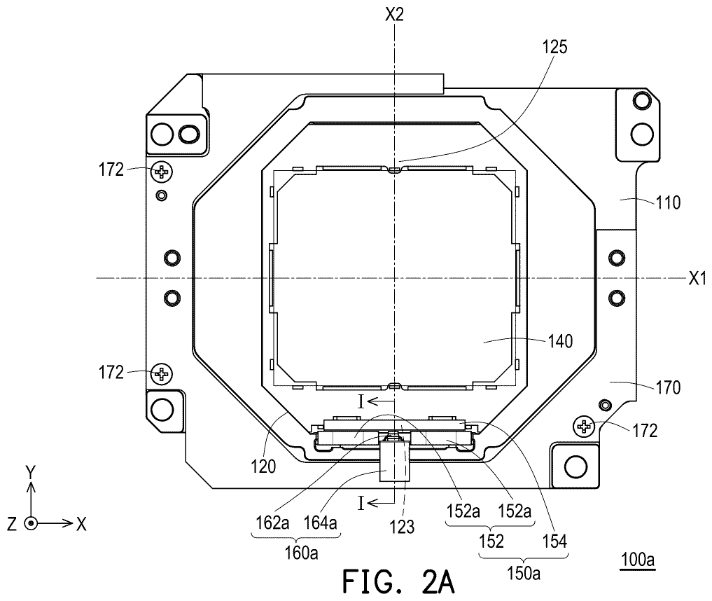

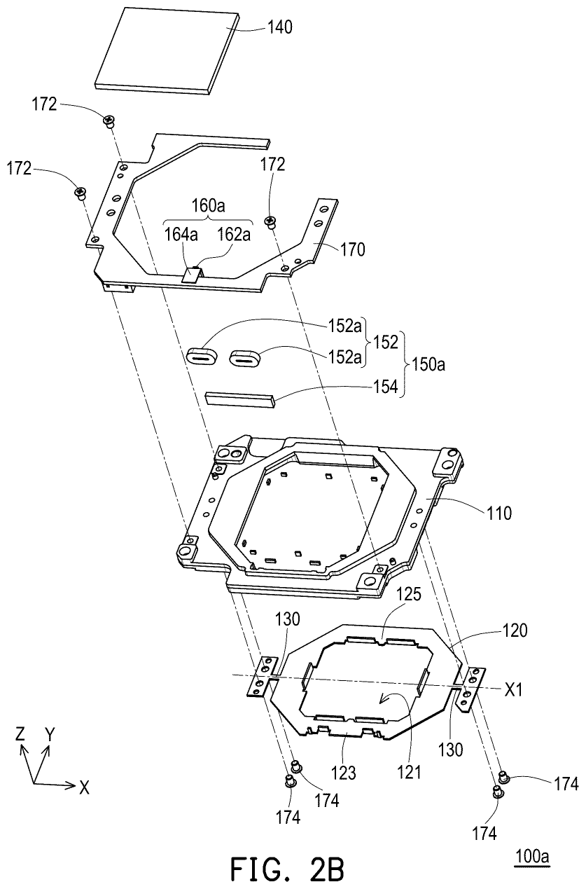

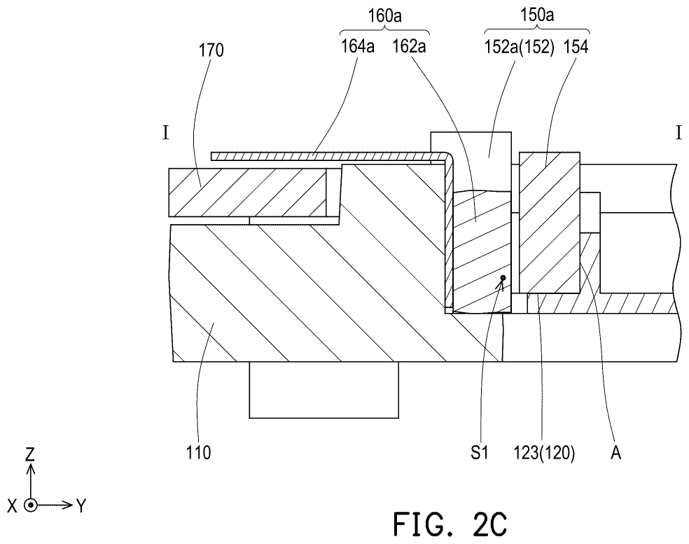

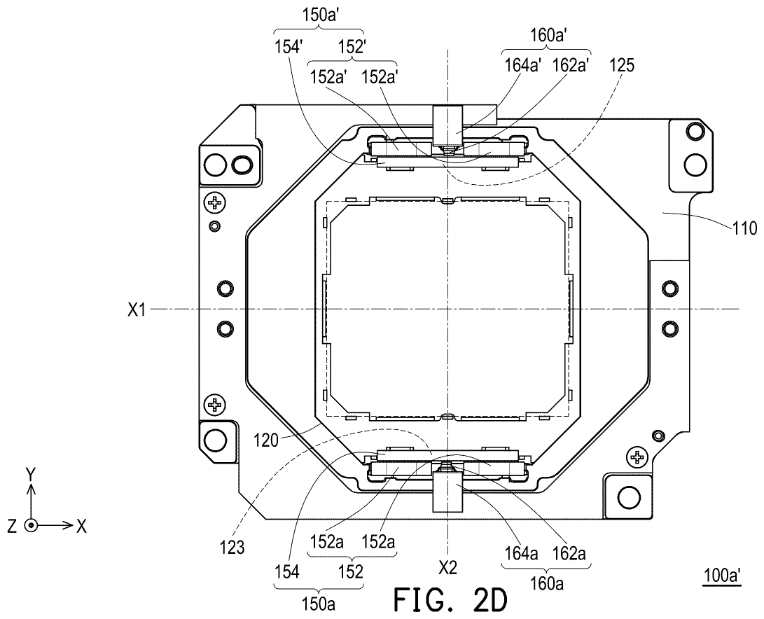

FIG. 2A is a schematic top perspective view of the actuating device in FIG. 1. FIG. 2B is a schematic three-dimensional exploded view of FIG. 2A. FIG. 2C is a schematic cross-sectional view along a line I-I of FIG. 2A. Referring to FIG. 2A, FIG. 2B and FIG. 2C together, in the embodiment, the actuating device 100a includes a base 110, a frame body 120, two first shaft portions 130, an optical element 140, a frame body driving assembly 150a and a frame body sensing module 160a. The frame body 120 is swingably connected to the base 110, where the base 110 is a non-moving component (stationary component) with a hollow area, and the frame body 120 is a movable component and is partially disposed in the hollow area of the base 110. The frame body 120 includes an opening 121, and the opening 121 is located between the two first shaft portions 130. The two first shaft portions 130 extend along a first axis X1 and are respectively connected to two opposite sides of the frame body 120. Each of the first shaft portions 130 is located between the frame body 120 and the base 110, and the frame body 120 is swingably connected to the base 110 through the first shaft portion 130. The frame body 120 further has two first side walls 123 and 125 located on a second axis X2 and opposite to each other, where the first axis X1 is perpendicular to the second axis X2.

Referring to FIG. 1 and FIG. 2A together, the optical element 140 of the embodiment is disposed in the opening 121 of the frame body 120. The optical element 140 may be, for example, a light-transmitting element (such as a glass) or a reflective element (such as a mirror) configured to receive the image beam L2 from the light valve 14 and transmit or reflect the image beam L2, so that the optical element 140 may deviate from a transmission path of the image beam L2 as the frame body 120 swings, so as to adjust a projection position of the image beam L2, causing position shift of each pixel of the image, thereby improving the resolution of the projected image. In the embodiment, the optical element 140 is, for example, a light-transmitting element. The controller 18 in the projector 10 may output a driving signal to drive the optical element 140 of the actuating device 100a to swing. The frame body sensing module 160a in the actuating device 100a is configured to sense a swing position of the optical element 140, and accordingly generates position information for sending back to the controller 18.

Referring to FIG. 2A, FIG. 2B, and FIG. 2C together, the frame body driving assembly 150a of the embodiment is configured to drive the frame body 120 to swing about the two first shaft portions 130 as rotating axes, so that the frame body 120 drives the optical element 140 to swing back and forth relative to the base 110. The frame body driving assembly 150a includes a first coil 152 and a first magnetic element 154. The first magnetic element 154 is disposed on one of the two first side walls 123 and 125 of the frame body 120 and is located between the first coil 152 and the frame body 120. Here, the first magnetic element 154 is disposed on the first side wall 123 of the frame body 120. In the embodiment, the first side wall 123 may be an external structural surface of the frame 120, such as a surface parallel to the second axis X2 and the opening 121, or a surface perpendicular to the second axis X2 and facing away from the opening 121, such as surface A. The first coil 152 corresponds to the first magnetic element 154 and is disposed on the base 110. When the first coil 152 receives a control signal (e.g. an electrical signal) from the controller 18 (as shown in FIG. 1) and generates an induced magnetic field, the first magnetic element 154 located on the frame body 120 may be driven according to the induced magnetic field generated by the first coil 152, so that the optical element 140 located on the frame body 120 and the first magnetic element 154 may swing back and forth relative to the first coil 152 on the base 110 with the first axis X1 as the actuating axis.

The frame body sensing module 160a of the embodiment is connected to the base 110 and includes a frame body sensor 162a, where the frame body sensor 162a is a magnetic flux sensor, such as a Hall sensor. The frame body sensor 162a is disposed adjacent to the first magnetic element 154 to sense an amount of change in magnetic field strength of the first magnetic element 154. Namely, since the first magnetic element 154 of the frame body driving assembly 150a is disposed on the first side wall 123 of the frame body 120, when the first magnetic element 154 drives the frame body 120 to swing together, a relative distance between the first magnetic element 154 and the frame body sensor 162a also changes, so that the frame body sensor 162a may sense a magnetic field strength change of the first magnetic element 154. In brief, the actuating device 100a of the embodiment is embodied as an actuator driven by a single-axis driving assembly and a sensing module. For example, referring to FIG. 2D, FIG. 2D is a top view of an actuating device added with a driving assembly and a sensing module based on FIG. 2A. In the embodiment, an actuating device 100a′ is similar to the above-mentioned actuating device 100a, but a main difference there between is that the actuating device 100a′ further includes another frame body driving assembly 150a′ and another frame body sensing module 160a′. It should be noted that the structures of another frame body driving assembly 150a′ and another frame body sensing module 160a′ added in the embodiment are the same as that of the frame body driving assembly 150a and the frame body sensing module 160a in FIG. 2A, so that the two first magnetic elements 154 and 154′ of the frame body driving assemblies 150 and 150a′ are respectively disposed on the two first side walls 123 and 125, and the two frame body sensors 162a and 162a′ of the two frame body sensing modules 160a and 160a′ are respectively disposed adjacent to the two first magnetic elements 154 and 154′. In other words, the first magnetic element 154′ of the another frame body driving assembly 150a′ is disposed on another one of the two first side walls 123, 125, i.e., the first side wall 125, and the frame body sensor 162a′ of the another frame body sensing module 160a′ is disposed adjacent to the first magnetic element 154′. In the embodiment, the first magnetic element 154′ is, for example, disposed on the first side wall 125 of the frame body 120 on a surface perpendicular to the second axis X2, and the surface faces in a direction away from the opening 121.

Referring to FIG. 2A, FIG. 2B, FIG. 2C, and FIG. 2D, in the embodiment, a configuration relationship between the frame body sensor 162a and the first magnetic element 154 is the same as that between the frame body sensor 162a′ and the first magnetic element 154′. Next, only the configuration relationship between the frame body sensor 162a and the first magnetic element 154 is described below. The frame body sensor 162a and the first magnetic element 154 are spaced apart by a specific distance, where the specific distance is, for example, 0.5 mm to 1.5 mm, which may effectively enhance the accuracy of magnetic flux sensing while preventing the frame body sensor 162a and the first magnetic element 154 from colliding during operation. Furthermore, orthogonal projections of the frame body sensor 162a and the first magnetic element 154 on a plane parallel to the beam incident/exit surface of the optical element 140 do not overlap.

Furthermore, referring to FIG. 2A and FIG. 2B together, in the embodiment, the first coil 152 of the frame body driving assembly 150a includes two first coil portions 152a connected in series, which may receive the same control signal from the controller 18 (as shown in FIG. 1). In a direction parallel to the first axis X1, the frame body sensor 162a is located between the two first coil portions 152a. Referring to FIG. 2D synchronously, another frame body driving assembly 150a′ further includes a first coil 152′. The first coil 152′ includes two first coil portions 152a′ connected in series. Since the other frame body driving assembly 150a′ has the same function as the frame body driving assembly 150a, description is not repeated.

Referring FIG. 2A and FIG. 2B, the first magnetic element 154 of the embodiment is, for example, a two-side four-pole magnet, i.e., there is an N pole and an S pole on one side, and the magnet may be an integrally formed structure, or may be formed by sticking two one-side one-pole magnets together. Referring to FIG. 2C again, in the embodiment, the frame body sensor 162a has a sensing center S1, and the sensing center S1 is located at a position where a magnetic flux of the first magnetic element 154 is sensed to be zero, which may have a relatively sensitive magnetic flux change.

Please refer to FIG. 2A and FIG. 2B together, in the embodiment, the actuating device 100a further includes a fixing portion 170 and fasteners 172 and 174. The fixing portion 170 (e,g, may be a circuit board (printed circuit board)) may be fixed on one side of the base 110 through the fasteners 172, and the frame body 120 may be fixed on the other side of the base 110 through the fasteners 174. In the embodiment, the fixing portion 170 is, for example, disposed at an edge of the base 110. In other embodiments, the fixing portion 170 may be disposed at other positions of the base 110, as long as it does not affect the operation of the actuating device 100a. In an embodiment, the fasteners 172 and 174 may be, for example, elastic pieces, screws or bolts. The frame body sensing module 160a of the embodiment further includes a first circuit board 164a, where the first circuit board 164a (one end) is fixed to the base 110 through the fixing portions 170, and the frame body sensor 162a is fixed to the first circuit board 164a (the other end). The first circuit board 164a is, for example, a rigid board, i.e., a printed circuit board, but may also be a flexible circuit board depending on specific structural requirements. Referring to FIG. 2D, another frame body sensing module 160a′ also includes a first circuit board 164a′, and since the function thereof is the same as that of the first circuit board 164a, details thereof are not repeated.

In brief, the frame body sensor 162a is configured to sense the amount of change in magnetic field strength of the first magnetic element 154 of the frame body driving assembly 150a to indirectly monitor an image pixel displacement, and the frame body sensor 162a feeds back the detected data to the controller 18 (as shown in FIG. 1), and the controller 18 may adjust a digital waveform and gain data (GAIN) according to the received data, so as to so as to optimize a displacement of pixel shift (such as reducing error/variation amount) by using a control method of a closed loop system. Compared with the prior art that senses additionally configured magnets, the frame body sensor 162a of the disclosure directly senses an amount of change in magnetic field strength of the first magnetic element 154 of the frame body driving assembly 150a, so that additional configuration of the magnets are not required, which may effectively save space. The projector 10 (as shown in FIG. 1) using the actuating device 100a (or the actuating device 100a′) of the disclosure may improve a resolution of a projected image.

Other embodiments will be further provided below as illustrations. It should be noticed that reference numbers of the components and a part of contents of the aforementioned embodiment are also used in the following embodiments, where the same reference numbers denote the same or like components, and descriptions of the same technical contents are omitted. The aforementioned embodiment may be referred for descriptions of the omitted parts, and detailed descriptions thereof are not repeated in the following embodiments.

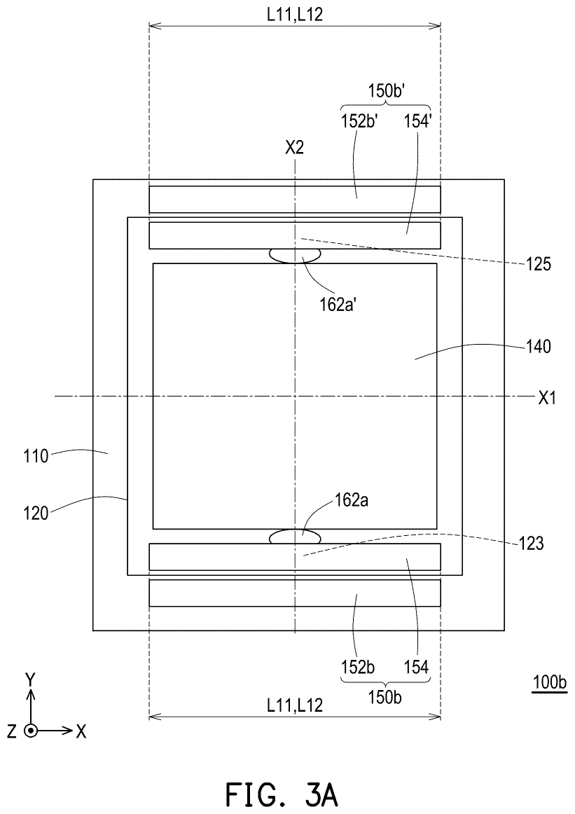

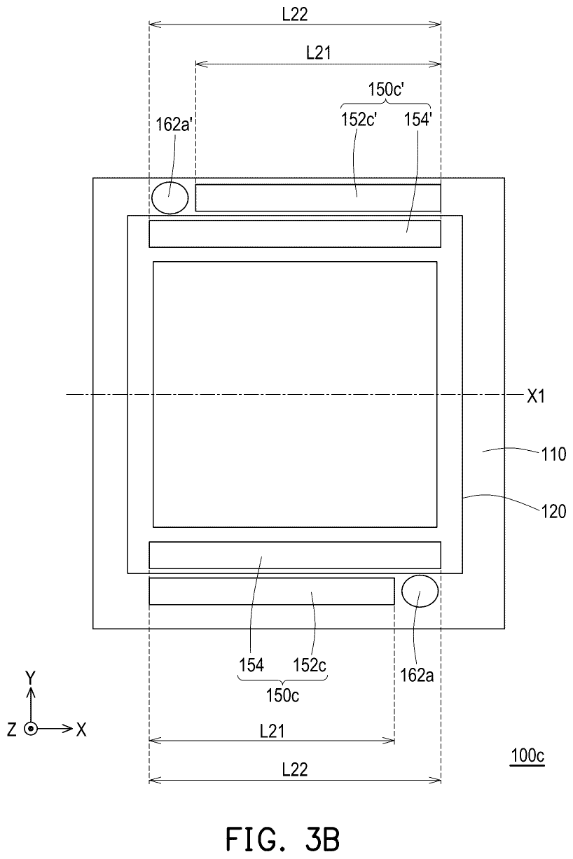

FIG. 3A is a schematic diagram of an actuating device according to an embodiment of the disclosure. FIG. 3A is used to illustrate the change in configuration positions of the frame body sensors 162a and 162a′. The remaining structures are the same as shown in FIG. 2D. Referring to FIG. 2D and FIG. 3A together, an actuating device 100b of the embodiment is similar to the above-mentioned actuating device 100a′, but a main difference there between is that in the embodiment, a first coil 152b includes one coil portion, which is different from the first coil 152 of FIG. 2D including two first coil portions 152a; similarly, a first coil 152b′ includes one coil portion, which is different from the first coil 152′ of FIG. 2D including two first coil portions 152a′. The first magnetic element 154, 154′ in the embodiment is located between the frame body sensor 162a, 162a′ and the first coil 152b, 152b′, which will be further discussed below.

In the embodiment, the frame body driving assembly 150b includes a first coil 152b and a first magnetic element 154, and the frame body sensing module includes a frame body sensor 162a. The structure of the frame body driving assembly 150b′ is the same as that of the frame body driving assembly 150b, i.e., it also includes a first coil 152b′ and a first magnetic element 154′. The structure of the frame body sensor 162a is the same as that of the frame body sensor 162a′.

Furthermore, the first magnetic elements 154 and 154′ of the frame body driving assemblies 150b and 150b′ are respectively disposed on the first side walls 123 and 125, and the frame body sensors 162a and 162a′ are respectively disposed adjacent to each other on the first magnetic element 154, 154′. As shown in FIG. 3A, the frame body sensors 162a and 162a′ are located between the optical element 140 and the first magnetic elements 154 and 154′, and the frame body sensors 162a and 162a′ are positioned along the second axis X2. On the other hand, on the second axis X2, the first magnetic element 154 is located between the frame body sensor 162a and the first coil 152b, and the first magnetic element 154′ is located between the frame body sensor 162a′ and the first coil 152b′. Here, in the direction parallel to the first axis X1, a first length L11 of the first coils 152b, 152b′ is equal to a second length L12 of the first magnetic elements 154, 154′, which ensures the uniformity of magnetic field distribution, thereby guaranteeing the stable sensing performance of the frame body sensors 162a and 162a′ at different positions. In brief, the actuating device 100b of the embodiment is embodied as an actuator driven by two single-axis driving assemblies and two sensing modules, but the disclosure it is not limited thereto.

FIG. 3B is a schematic diagram of an actuating device according to another embodiment of the disclosure. FIG. 3B is used to illustrate the change in configuration positions of the frame body sensors 162a and 162a′. The remaining structures are the same as shown in FIG. 2D. Referring to FIG. 3A and FIG. , an actuating device 100c of the embodiment is similar to the above-mentioned actuating device 100b. However, a main difference there between is that in the embodiment, in the direction parallel to the first axis X1, a first length L21 of a first coil 152c of a frame body driving assembly 150c is less than a second length L22 of the first magnetic element 154 to optimize the magnetic field distribution and improve the sensing precision. The frame body sensor 162a of the frame body sensing module and the first coil 152c are sequentially arranged in the direction parallel to the first axis X1, and the frame body sensor 162a is located on one side of the first coil 152c. In the direction parallel to the first axis X1, the first length L21 of the first coil 152c′ of the frame body driving assembly 150c′ is less than the second length L22 of the first magnetic element 154′, and the frame body sensor 162a′ of the frame body sensing module and the first coil 152c′ are sequentially arranged in a direction parallel to the first axis X1 and the frame body sensors 162a′ is located on one side of the first coil 152c′. Here, the frame body sensor 162a and the frame body sensor 162a′ are respectively on opposite sides of the first coils 152c, 152c′. For example, the frame body sensor 162a is located on the right side of the first coil 152c, and the frame body sensor 162a′ is located on the left side of the first coil 152c′, i.e., at diagonal positions, forming a diagonal configuration to achieve structural balance and improve space utilization.

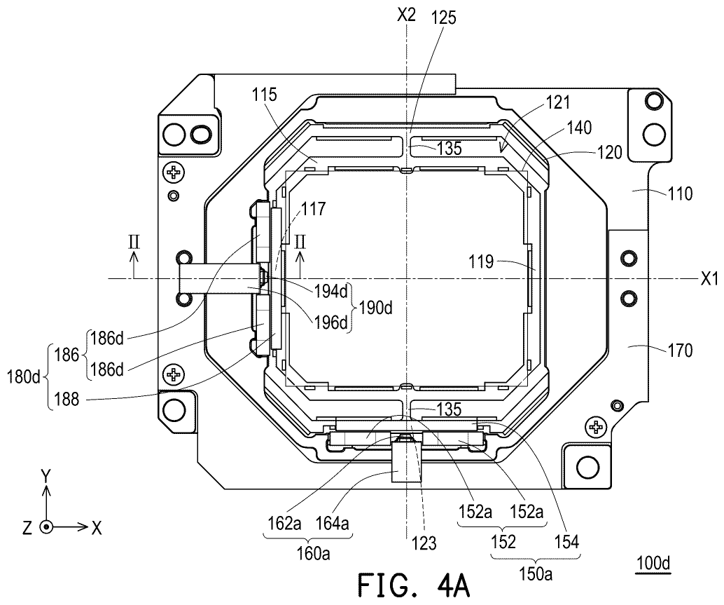

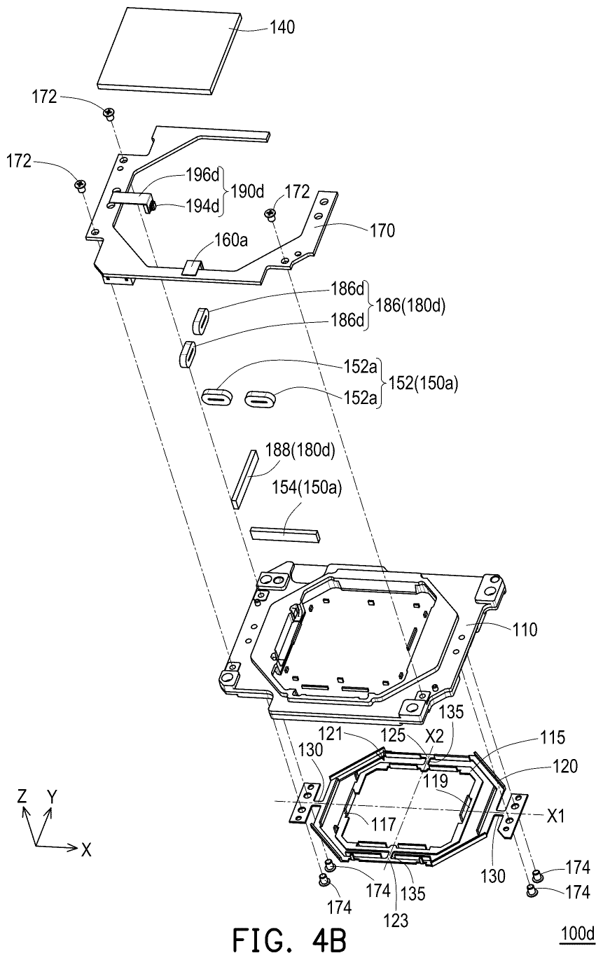

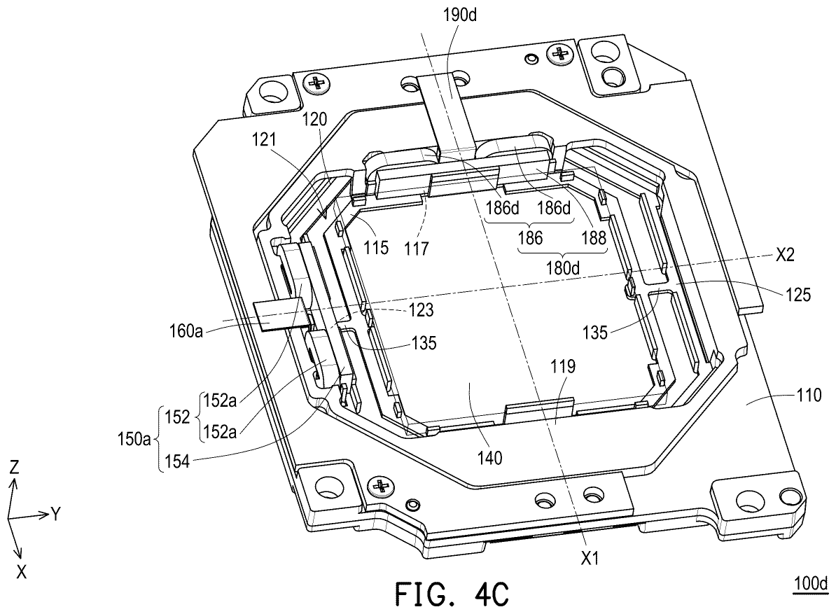

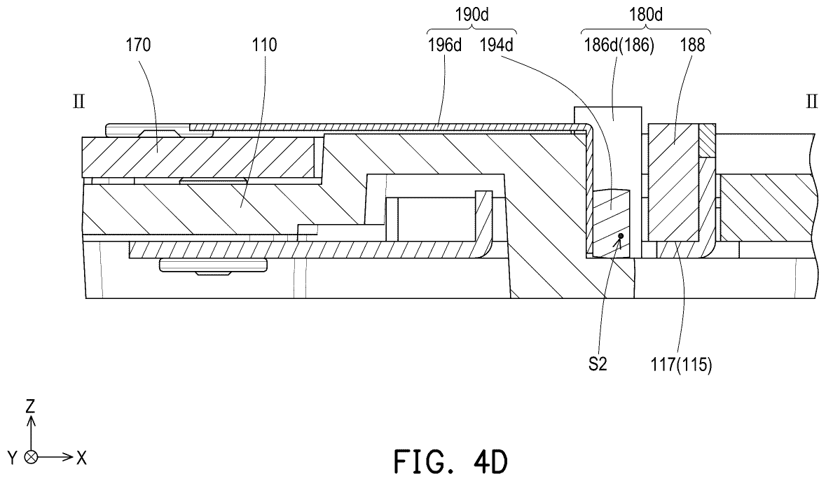

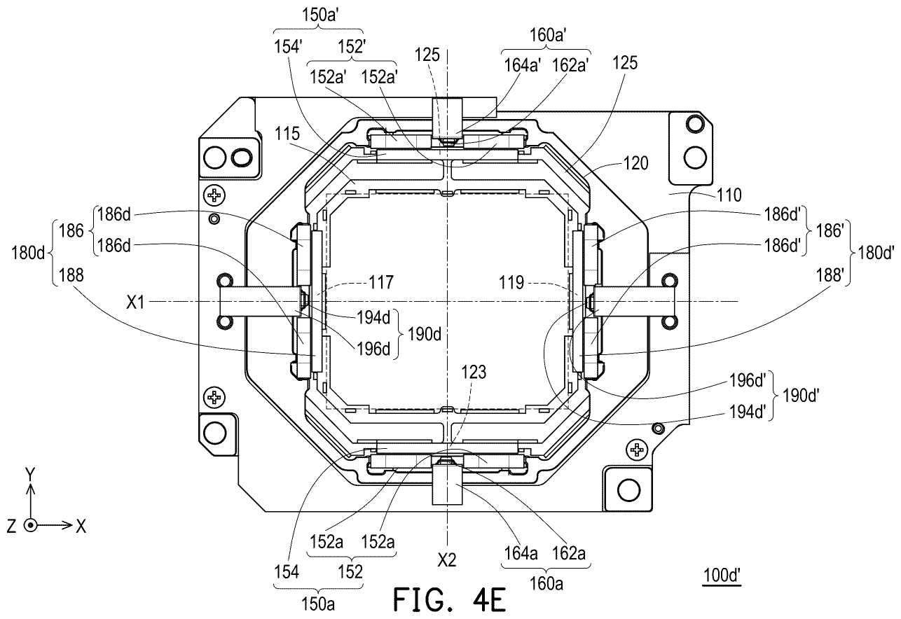

FIG. 4A is a top perspective view of an actuating device according to another embodiment of the disclosure. FIG. 4B is a schematic three-dimensional exploded view of FIG. 4A. FIG. 4C is a schematic three-dimensional view of FIG. 4A from another viewing angle. FIG. 4D is a schematic cross-sectional view along a line II-II of FIG. 4A. Referring to FIG. 2A, FIG. 4A, FIG. 4B, FIG. 4C, and FIG. 4D together, an actuating device 100d of the embodiment is similar to the above-mentioned actuating device 100a, and a main difference there between is that in the embodiment, the actuating device 100d further includes a frame portion 115 and two second shaft portions 135, where the frame portion 115 has a hollow structure and is disposed in the opening 121 of the frame body 120. The optical element 140 is disposed in the hollow structure of the frame portion 115, i.e., in the frame portion 115. The frame portion 115 is located between the optical element 140 and the frame body 120. The frame portion 115 has two second side walls 117 and 119 located on the first axis X1 and opposite to each other. The two second shaft portions 135 extend along the second axis X2 and are respectively connected to two opposite sides of the frame portion 115, and the two second shaft portions 135 are respectively located between the frame portion 115 and the two first side walls 123 and 125 of the frame body 120.

The actuating device 100d of the embodiment further includes a frame portion driving assembly 180d and a frame portion sensing module 190d. The frame portion driving assembly 180d is configured to drive the frame portion 115 to swing relative to the frame 120 about the two second shaft portions 135 as rotating axes, so that the frame portion 115 drives the optical element 140 to swing back and forth relative to the base 110. The frame portion driving assembly 180d includes a second coil 186 and a second magnetic element 188. The second magnetic element 188 is disposed on one of the two second side walls 117 and 119 of the frame portion 115 and is located between the second coil 186 and the frame portion 115. Here, the second magnetic element 188 is disposed on the second side wall 117 of the frame portion 115. In the embodiment, the second side wall 117 may be a surface parallel to the first axis X1 and the opening 121, or a surface perpendicular to the first axis X1 and facing away from the opening 121. The second coil 186 corresponds to the second magnetic element 188 and is disposed on the base 110. When the second coil 186 receives a control signal (i.e. an electrical signal) from the controller 18 (as shown in FIG. 1) and generates an induced magnetic field, the second magnetic element 188 located on the frame portion 115 may be driven according to the induced magnetic field generated by the second coil 186, so that the optical element 140 located on the frame portion 115 and the second magnetic element 188 may swing back and forth relative to the second coil 186 on the base 110. The frame portion sensing module 190d is connected to the base 110 and includes a frame portion sensor 194d, where the frame portion sensor 194d is a magnetic flux sensor, such as a Hall sensor. The frame portion sensor 194d is disposed adjacent to the second magnetic element 188 to sense an amount of change in magnetic field strength of the second magnetic element 188.

In other words, since the second magnetic element 188 of the frame portion driving assembly 180d is disposed on the second side wall 117 of the frame portion 115, when the frame portion 115 swings, the second magnetic element 188 may also swing together, accordingly, a distance between the second magnetic element 188 and the frame portion sensor 194d may also change, so that the frame portion sensor 194d may sense the magnetic field strength change of the second magnetic element 188. In brief, the actuating device 100d of the embodiment is embodied as a biaxial actuator with one driving assembly and one sensing module on each axis. For example, referring to FIG. 4E, FIG. 4E is a top view of an actuating device added with a driving assembly and a sensing module based on FIG. 4A. In the embodiment, an actuating device 100d′ is similar to the actuating device 100d of FIG. 4A mentioned above, but a main difference there between is that the actuating device 100d′ further includes another frame body driving assembly 150a′, another frame body sensing module 160a′, another frame portion driving assembly 180d′, and another frame portion sensing module 190d′. It should be noted that the structures of the another frame body driving assembly 150a′ and the another frame body sensing module 160a′ added in the embodiment are the same as those of the frame body driving assembly 150a and the frame body sensing module 160a in FIG. 4A, so that details thereof are not repeated.

The structure of the another frame portion driving assembly 180d′ and the another frame portion sensing module 190d′ added in the embodiment are the same as the frame portion driving assembly 180d and frame portion sensing module 190d in FIG. 4A. Therefore, the two second magnetic elements 188 and 188′ of the two frame portion driving assemblies 180d and 180d′ are respectively disposed on the two second side walls 117 and 119, and the two frame portion sensors 194d and 194d′ of the two frame portion sensing modules 190d, 190d′ are respectively disposed adjacent to the two second magnetic elements 188 and 188′. In other words, the second magnetic element 188′ of the other frame portion driving assembly 180d′ is disposed on the other one of the two second side walls 117, 119, i.e., the second side wall 119, and the frame portion sensor 194d′ of the other frame portion sensing module 190d′ is disposed adjacent to the second magnetic element 188′.

It should be noted that in the embodiment, the frame portion sensor 194d and the second magnetic element 188 are spaced apart at a specific distance, where the specific distance is, for example, 0.5 mm to 1.5 mm, which is a preferred distance at which magnetic flux may be sensed, and the frame portion sensor 194d and the second magnetic element 188 will not collide with each other. Orthogonal projections of the frame portion sensor 194d and the second magnetic element 188 on a plane parallel to the beam incident/exit surface of the optical element 140 do not overlap.

Furthermore, referring to FIG. 4A, FIG. 4B, FIG. 4C, and FIG. 4E together, in the embodiment, the second coil 186 of the frame portion driving assembly 180d includes two second coil portions 186d connected in series, i.e., the same control signal from the controller 18 (as shown in FIG. 1) may be used, and in the direction parallel to the second axis X2, the frame portion sensor 194d is located between the two second coil portions 186d. Preferably, the frame portion sensor 194d is located on the first axis X1. Therefore, when the frame body 120 swings about the first axis X1 as a rotating axis, as the frame portion sensor 194d is located on the first axis X1, the frame portion sensor 194d will not sense the amount of change in magnetic field strength of the second magnetic element 188, and the frame portion sensor 194d may sense the amount of change in magnetic field strength of the second magnetic element 188 only when the frame portion 115 swings about the second axis X2 as a rotating axis. Therefore, position information obtained by the frame portion sensor 194d will not be affected by the swing of the frame body 120 along the first axis X1, and a better magnetic induction effect is achieved.

Referring to FIG. 4A, FIG. 4B, and FIG. 4C again, the second magnetic element 188 in the embodiment is, for example, a two-sided four-pole magnet, i.e., there is an N pole and an S pole on one side, and it may be an integrally formed structure, or may be formed by sticking two one-side one-pole magnets together. The frame portion sensing module 190d of the embodiment includes a second circuit board 196d, where the second circuit board 196d is fixed to the base 110 through the fixing portion 170, and the frame portion sensor 194d is fixed to the second circuit board 196d. Here, the second circuit board 196d is, for example, a rigid board, i.e., a printed circuit board.

Referring to FIG. 4D again, in the embodiment, the frame portion sensor 194d has a sensing center S2, and the sensing center S2 is located at a position where the magnetic flux of the second magnetic element 188 is sensed to be zero, which may have a relatively sensitive magnetic flux change.

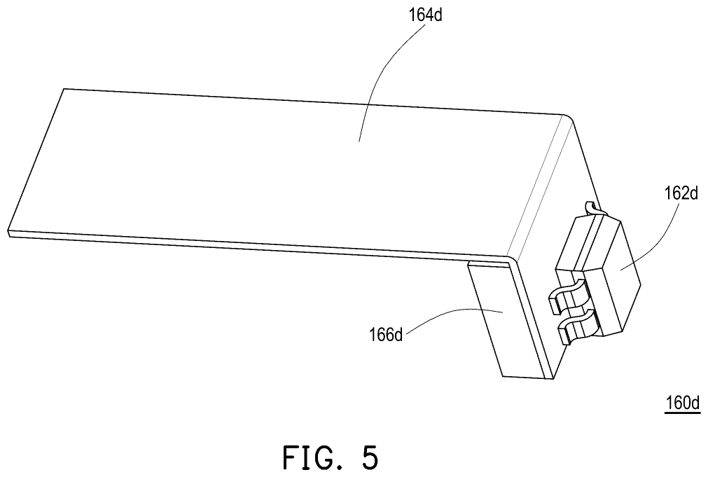

FIG. 5 is a schematic three-dimensional view of a sensing module according to an embodiment of the disclosure. It should be noted that a sensing module 160d of the embodiment may be, for example, the above-mentioned frame body sensing module or frame portion sensing module. In the embodiment, the sensing module 160d may further include a support member 166d, where the support member 166d and a sensor 162d are respectively fixed on two opposite sides of a first circuit board 164d. Here, the first circuit board 164d is, for example, a flexible board, such as a flexible circuit board. Therefore, the support member 166d must be provided on the side corresponding to the sensor 162d to compensate for rigidity. In an embodiment, the support member 166d may be, for example, a substrate. The frame body sensing module or frame portion sensing module mentioned below is also applicable to the sensing module 160d of the embodiment, which is not limited by the disclosure.

It should be noted that in the following embodiments, the same or similar components are represented by the same numerical number as those in FIG. 4A to FIG. 4E, and the only difference lies in the English letters following the numbers.

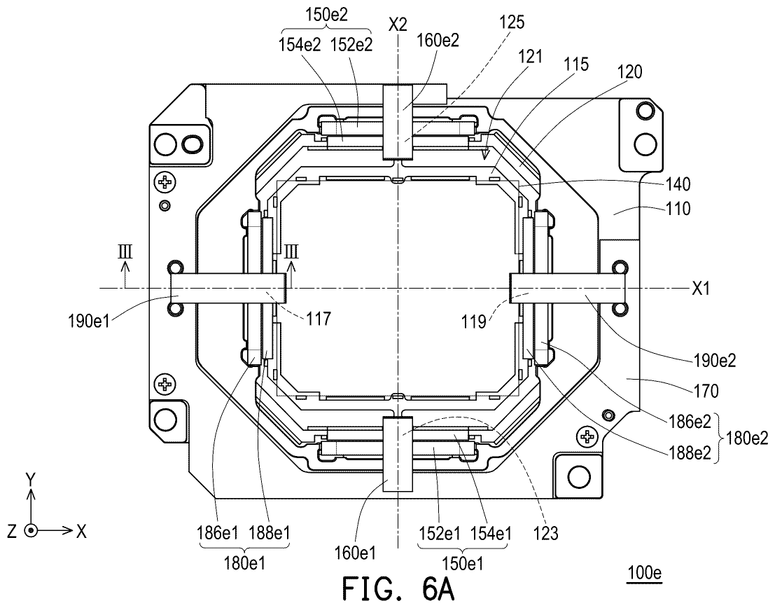

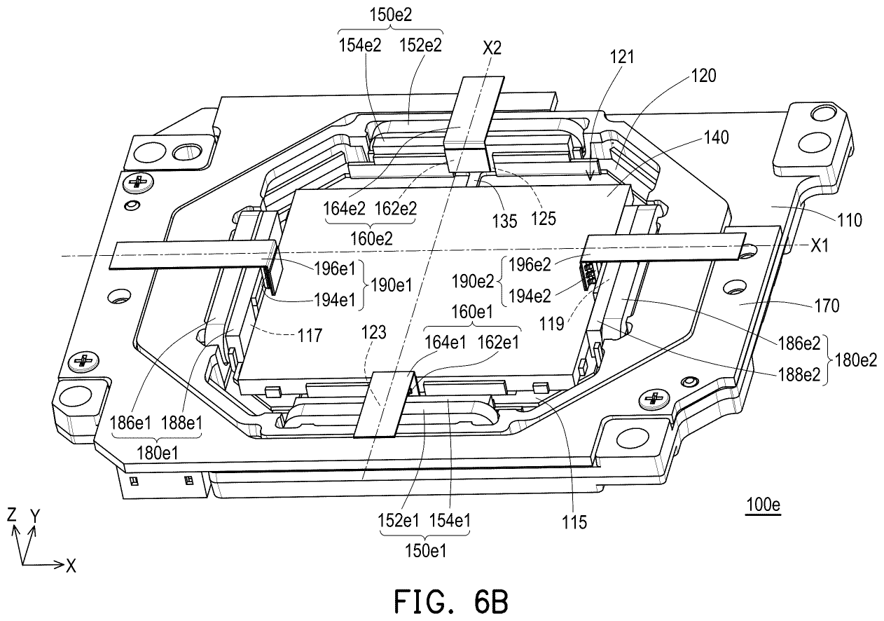

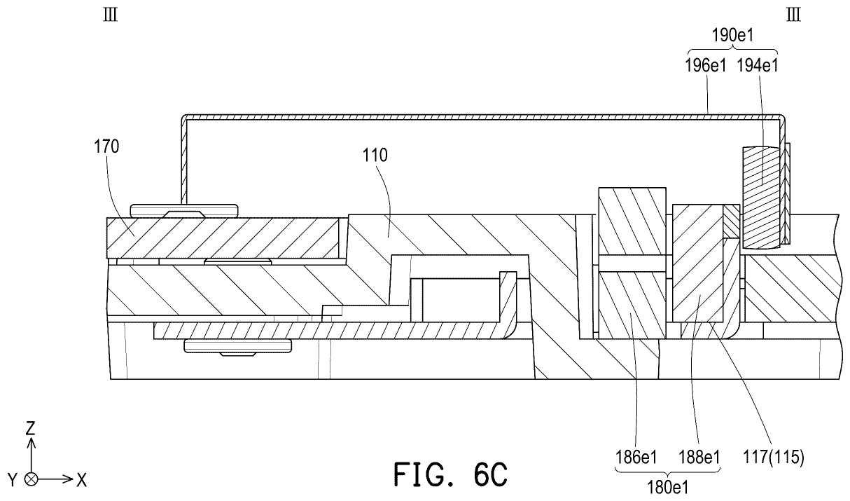

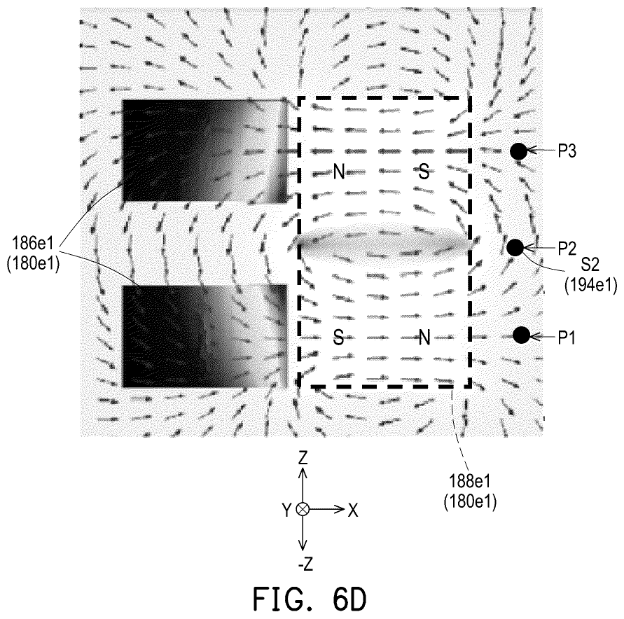

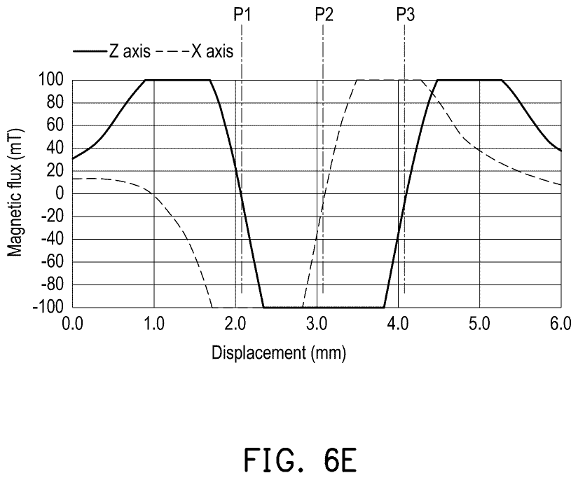

FIG. 6A is a schematic top perspective view of an actuating device according to another embodiment of the disclosure. FIG. 6B is a schematic three-dimensional view of FIG. 6A from another viewing angle. FIG. 6C is a schematic cross-sectional view along a line III-III of FIG. 6A. FIG. 6D is a schematic image of magnetic field distribution simulation of a driving assembly and a sensing module of FIG. 6A. FIG. 6E is a schematic curve graph of displacement and magnetic flux of the tested sensing module in FIG. 6D.

Referring to FIG. 4A, FIG. 6A, FIG. 6B, and FIG. 6C together, an actuating device 100e of the embodiment is similar to the above-mentioned actuating device 100d, and a main difference there between is that in the embodiment, the actuating device 100e further includes another frame body driving assembly 150e2 and another frame body sensing module 160e2. It should be noted that the frame body driving assembly 150a of FIG. 4A is similar to the frame body driving assembly 150e1 of the embodiment, and the only difference is that the first coil 152e1 of the frame body driving assembly 150e of the embodiment is a coil portion, which is different from the first coil 152 of FIG. 4A that includes two first coil portions 152a, and the first coil 152e2 of the other newly added frame body driving assembly 150e2 in the embodiment is one coil portion, which is different from the first coil 152 of FIG. 4A that includes two first coil portions 152a. The frame body driving assembly 150e1 includes a first coil 152e1 and a first magnetic element 154e1, and the frame body sensing module 160e1 includes a frame body sensor 162e1 and a first circuit board 164e1. The structure of the frame body driving assembly 150e2 is the same as that of the frame body driving assembly 150e1, i.e., it also includes the first coil 152e2 and the first magnetic element 154e2. The structure of the frame body sensing module 160e2 is the same as that of the frame body sensing module 160e1, i.e., it also includes a frame body sensor 162e2 and a first circuit board 164e2. The first magnetic elements 154e1 and 154e2 of the frame body driving assemblies 150e1 and 150e2 are respectively disposed on the first side walls 123 and 125, and the frame body sensors 162e1 and 162e2 of the frame body sensing modules 160e1 and 160e2 are respectively disposed adjacent to the first magnetic elements 154e1 and 154e2. Here, the frame body sensor 162e1, the first magnetic element 154e1, and the first coil 152e1 are sequentially arranged along the direction of the second axis X2; and the frame body sensor 162e2, the first magnetic element 154e2, and the first coil 152e2 are sequentially arranged along the direction of the second axis X2.

Furthermore, the actuating device 100e of the embodiment further includes another frame portion driving assembly 180e2 and another frame portion sensing module 190e2. It should be noted that the frame portion driving assembly 180d of FIG. 4A is similar to the frame portion driving assembly 180e1 of the embodiment, and a difference there between is only that the second coil 186e1 of the frame portion driving assembly 180e1 of the embodiment is one coil portion, which is different from the second coil 186 of FIG. 4A that includes two second coil portions 186d, and the second coil portion 186e2 of the other frame portion driving assembly 180e2 added in the embodiment is one coil portion, which is different from the second coil 186 of FIG. 4A that includes two second coil portions 186d. The frame portion driving assembly 180e1 includes a second coil 186e1 and a second magnetic element 188e1, and the frame portion sensing module 190e1 includes a frame portion sensor 194e1 and a second circuit board 196e1. The structure of the frame portion driving assembly 180e2 is the same as that of the frame portion driving assembly 180e1, i.e., it also includes a second coil 186e2 and a second magnetic element 188e2. The structure of the frame portion sensing module 190e2 is the same as that of the frame portion sensing module 190e1, i.e., it also includes a frame portion sensor 194e2 and a second circuit board 196e2. The second magnetic elements 188e1 and 188e2 of the frame portion driving assemblies 180e1 and 180e2 are respectively disposed on the second side walls 117 and 119, and the frame portion sensors 194e1 and 194e2 of the frame portion sensing modules 190e1 and 190e2 are respectively disposed adjacent to the second magnetic elements 188e1 and 188e2. Here, the frame portion sensor 194e1, the second magnetic element 188e1, and the second coil 186e1 are sequentially arranged along the direction of the first axis X1; and the frame portion sensor 194e2, the second magnetic element 188e2, and the second coils 186e2 are sequentially arranged along the direction of the first axis X1.

Furthermore, along the second axis X2, the first magnetic elements 154e1 and 154e2 are located between the frame body sensors 162e1 and 162e2 and the first coils 152e1 and 152e2. On the other hand, on the first axis X1, the second magnetic elements 188e1 and 188e2 are located between the frame portion sensors 194e1 and 194e2 and the second coils 186e1 and 186e2.

When the frame portion 115 swings along the second axis X2, the frame portion sensors 194e1 and 194e2 may sense the amount of change in magnetic field strengths of the corresponding second magnetic elements 188e1 and 188e2; similarly, if the frame body 120 swings along the first axis X1, the frame body sensors 162e1 and 162e2 may sense the amount of change in magnetic field strengths of the corresponding first magnetic elements 154e1 and 154e2. Namely, the frame portion sensors 194e1 and 194e2 may sense amount of change in magnetic field strengths of the second magnetic elements 188e1 and 188e2, and the frame body sensors 162e1 and 162e2 may sense amount of change in magnetic field strengths of the first magnetic elements 154e1 and 154e2, the frame body sensors 162e1 and 162e2 and the frame portion sensors 194e1 and 194e2 feed back signals corresponding to the amount of change in magnetic field strength to the controller 18 (as shown in FIG. 1), thereby indirectly monitoring image pixel displacements, and the controller 18 is used to adjust the digital waveform and gain data (GAIN), so as to optimize the displacement of pixel shift (such as reducing error/variation amount) by using a control method of a closed loop system. In brief, the actuating device 100e of the embodiment is embodied as a biaxial actuator with two driving assemblies and two sensing modules operating on one axis.

Then, referring to FIG. 6D and FIG. 6E, positions P1, P2, and P3 in FIG. 6D represent configurable positions of sensing centers of the sensors (such as the frame body sensors 162e1 and 162e2 or the frame portion sensors 194e1 and 194e2), where the magnetic elements (such as the first magnetic elements 154e1, 154e2 or the second magnetic elements 188e1, 188e2) moves relative to the coils (such as the first coils 152e1, 152e2 or the second coils 186e1, 186e2) and the sensors on the Z axis (perpendicular to the first axis X1 and the second axis X2), and the magnetic elements, the coils and the sensors are arranged in an X axis (parallel to the first axis X1) direction. Here, the second coil 186e1, the second magnetic element 188e1 and the frame portion sensor 194e1 are used as an example for description.

When the second magnetic element 188e1 moves up and down along the Z axis (it should be noted that it may move along the Z and −Z axes or swing back and forth with Y axis as the rotation axis), a magnetic variation amount of the frame portion sensor 194e1 corresponding to the Z axis may be measured. Here, the position P1 and the position P3 correspond to the positions where the magnetic lines of force of the second magnetic element 188e1 are horizontal, and the position P2 corresponds to the position where the magnetic lines of force of the second magnetic element 188e1 are vertical. Namely, when the sensing center S2 of the frame portion sensor 194e1 is positioned at the position P2, the sensing center S2 corresponds to the position where the magnetic field generated by the second magnetic element 188e1 is weakest along the X axis direction; and when the sensing center S2 of the frame portion sensor 194e1 is positioned at the position P1 or the position P3, the sensing center S2 corresponds to the position where the magnetic field generated by the second magnetic element 188e1 is weakest along a Z axis direction, which will be further explained below in FIG. 6E.

Referring to FIG. 6D and FIG. 6E, the horizontal axis is the displacement of the second magnetic element 188e1 relative to the frame portion sensor 194e1, and the vertical axis is a magnetic flux of the magnetic lines of force sensed when the frame portion sensor 194e1 senses the second magnetic element 188e1. It may be seen from FIG. 6E that since when the second magnetic element 188e1 moves up and down (or swing back and forth with Y axis as the rotation axis) along the Z axis (including the-Z axis), the frame portion sensor 194e1 may correspond to a linear working area, it may have a relatively sensitive magnetic flux change. The positions P1 and P3 are positions where the magnetic flux of the frame portion sensor 194e1 corresponding to the Z axis direction is zero, and the position P2 is a position where the magnetic flux of the frame portion sensor 194e1 corresponding to the X axis direction is zero. Therefore, when the sensing center S2 of the frame portion sensor 194e1 is positioned at the position P1, the position P2 or the position P3, it may have better sensitivity (better linear working area) to magnetic flux changes.

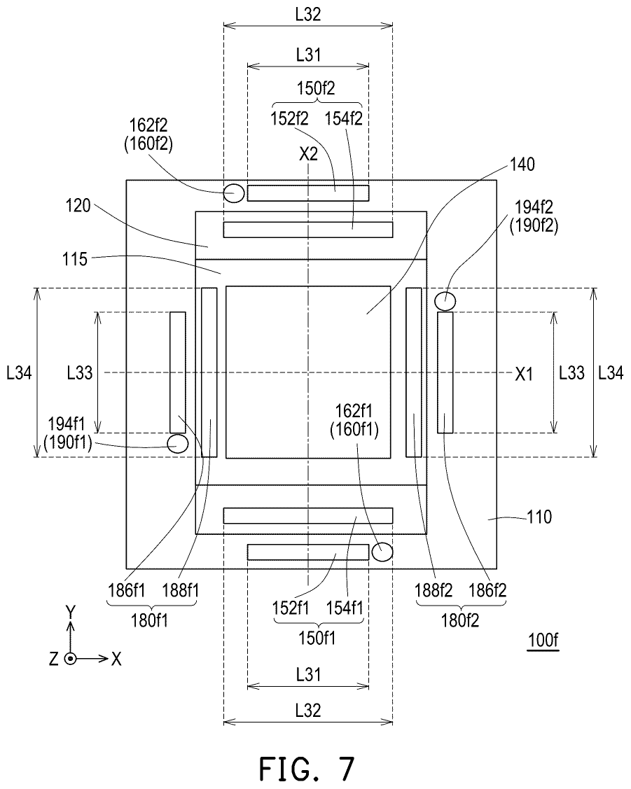

FIG. 7 is a schematic diagram of an actuating device according to another embodiment of the disclosure. FIG. 7 is used to illustrate the change in configuration positions of the frame body sensors 162f1 and 162f2 and the frame portion sensors 194f1 and 194f2. The remaining structures are the same as shown in FIG. 6A. Referring to FIG. 6A and FIG. 7 together, an actuating device 100f of the embodiment is similar to the above-mentioned actuating device 100e, and a main difference there between is that in the embodiment, in the direction parallel to the first axis X1, a first length L31 of first coils 152f1 and 152f2 of frame driving assemblies 150f1 and 150f2 is smaller than a second length L32 of first magnetic elements 154f1 and 154f2. Frame body sensors 162f1 and 162f2 of frame body sensing modules 160f1 and 160f2 and the first coils 152f1 and 152f2 are sequentially arranged in the direction parallel to the first axis X1, and the frame body sensors 162f1 and 162f2 are located on one side of the first coils 152f1 and 152f2. Here, the frame body sensors 162f1 and 162f2 are located on opposite sides of the first coils 152f1 and 152f2. For example, the frame body sensor 162f1 is located at the right side of the first coil 152f1 and the frame body sensor 162f2 is located at the left side of the first coil 152f2, i.e., at diagonal positions.

Furthermore, in the direction parallel to the second axis X2, a third length L33 of the second coils 186f1 and 186f2 of the frame portion driving assemblies 180f1 and 180f2 is smaller than a fourth length L34 of the second magnetic elements 188f1 and 188f2. The frame portion sensors 194f1 and 194f2 of the frame portion sensing modules 190f1 and 190f2 and the second coils 186f1 and 186f2 are sequentially arranged in the direction parallel to the second axis X2, and the frame portion sensors 194f1 and 194f2 are located on one side of the second coils 186f1 and 186f2. Here, the frame portion sensors 194f1 and 194f2 are located on the opposite sides of the second coils 186f1 and 186f2. For example, the frame portion sensor 194f1 is located at the lower side of the second coil 186f1, and the frame portion sensor 194f2 is located at the upper side of the second coil 186f2, i.e., at diagonal positions.

When the frame portion 115 swings along the second axis X2, the frame portion sensors 194f1 and 194f2 may sense amount of change in magnetic field strengths of the corresponding second magnetic elements 188f1 and 188f2; similarly, when the frame body 120 swings along the first axis X1, the frame body sensors 162f1 and 162f2 may sense amount of change in magnetic field strengths of the corresponding first magnetic elements 154f1 and 154f2. Namely, the frame portion sensors 194f1 and 194f2 may sense amount of change in magnetic field strengths of the second magnetic elements 188f1 and 188f2, and the frame body sensors 162f1 and 162f2 may sense amount of change in magnetic field strengths of the first magnetic elements 154f1 and 154f2, feeding back a signal corresponding to the amount of change in magnetic field strength to the controller 18 (as shown in FIG. 1), thereby indirectly monitoring image pixel displacements, and the controller 18 is used to adjust the digital waveform and gain data (GAIN), so as to optimize the displacement of pixel shift (such as reducing error/variation amount) by using a control method of a closed loop system.

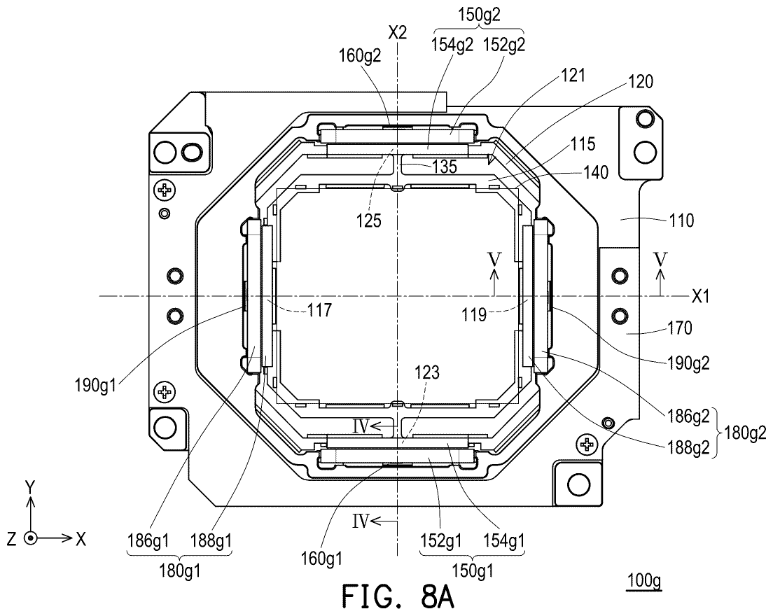

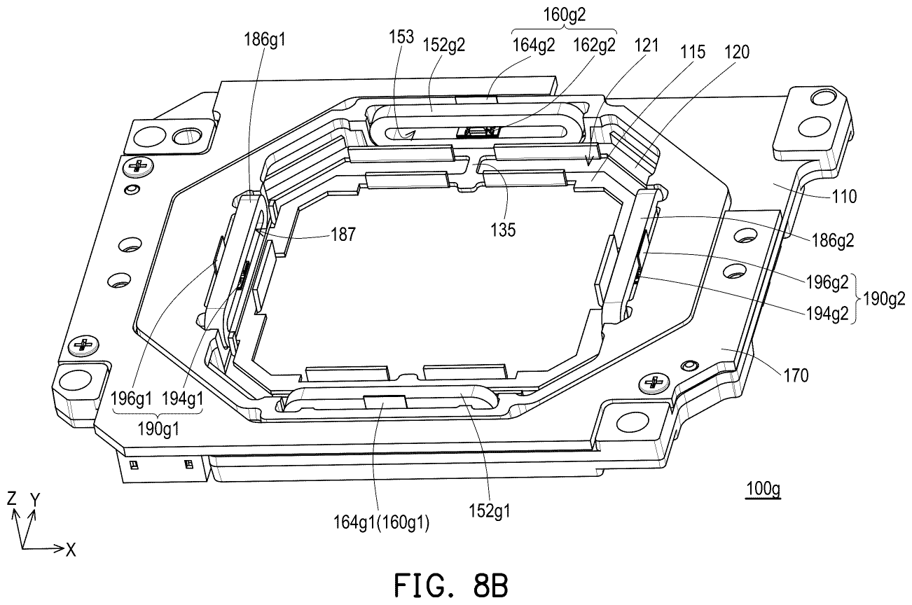

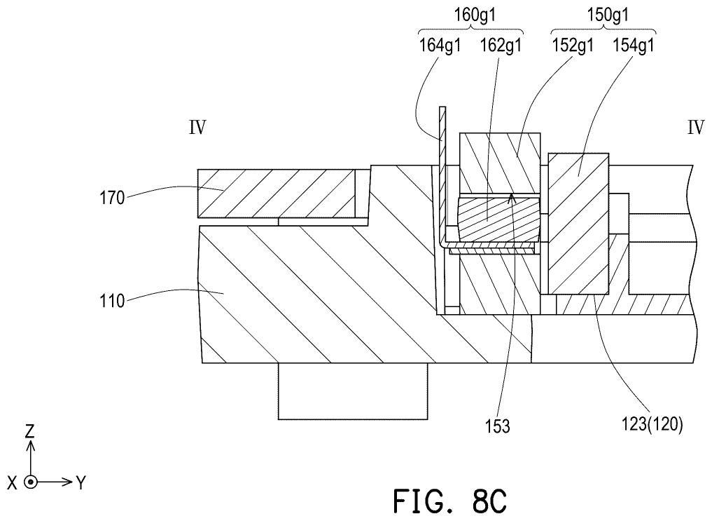

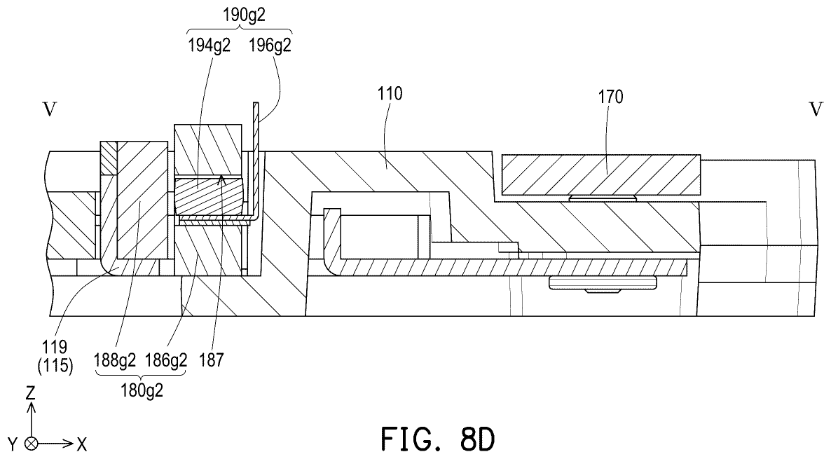

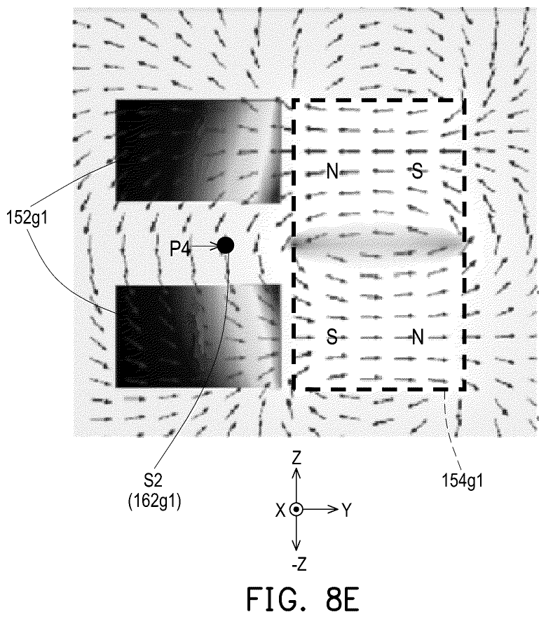

FIG. 8A is a schematic top perspective view of an actuating device according to another embodiment of the disclosure. FIG. 8B is a schematic three-dimensional view of FIG. 8A from another viewing angle. FIG. 8C is a schematic cross-sectional view along a line IV-IV of FIG. 8A. FIG. 8D is a schematic cross-sectional view along a line V-V of FIG. 8A. FIG. 8E is a schematic image of magnetic field distribution simulation of a driving assembly and a sensing module of FIG. 8A. It should be noted that, for clarity of illustration, the first magnetic element and the second magnetic element are omitted from FIG. 8B.

Referring to FIG. 6A, FIG. 8A, FIG. 8B, FIG. 8C and FIG. 8D, an actuating device 100g of the embodiment is similar to the above-mentioned actuating device 100e, and a main difference there between is that in the embodiment, the first coils 152g1 and 152g of the frame body driving assemblies 150g1 and 150g2 respectively have first openings 153, and the second coils 186g1 and 186g2 of the frame portion driving assemblies 180g1 and 180g2 respectively have second openings 187. The frame body sensors 162g1 and 162g2 of the frame body sensing modules 160g1 and 160g2 are respectively located in the first openings 153, where the first circuit boards 164g1 and 164g2 are respectively fixed on the base 110, and the frame body sensors 162g1 and 162g2 are respectively fixed on the first circuit boards 164g1, 164g2, and the frame body sensors 162g1, 162g2 are configured to detect magnetic flux changes of the first magnetic elements 154g1, 154g2 moving up and down (swing back and forth with the first axis X1 as the actuation axis). The frame portion sensors 194g1 and 194g2 of the frame portion sensing modules 190g1 and 190g2 are respectively located in the second openings 187, where the second circuit boards 196g1 and 196g2 are respectively fixed to the base 110, the frame portion sensors 194g1 and 194g2 are respectively fixed to the second circuit boards 196g1 and 196g2, and the frame portion sensors 194g1 and 194g2 are configured to detect magnetic flux changes of the second magnetic elements 188g1 and 188g2 moving up and down (swing back and forth with the second axis X2 as the actuation axis).

Then, referring to FIG. 8E, which is a schematic image of the magnetic field distribution simulation of the sensing module of FIG. 8C. A position P4 represents a configurable position of the sensing center of the sensor (such as the frame body sensor 162g1), where the magnetic element (such as the first magnetic element 154g1) operates relative to the coil (such as the first coil 152g1) and the sensor in the Z axis, and the magnetic element, the coil and the sensor are arranged in a Y axis direction. Here, the first coil 152g1, the first magnetic element 154g1 and the frame body sensor 162g1 are used as an example for description. When the first magnetic element 154g1 moves up and down along the Z axis (it should be noted that it may move along the Z and-Z axes, or swing back and forth with the X axis as the actuation axis), a variation amount of the frame body sensor 162g1 corresponding to the Z axis may be measured. Here, the position P4 corresponds to the position where the magnetic lines force of the first magnetic element 154g1 are vertical. Namely, when the sensing center S2 of the frame body sensor 162g1 is positioned at the position P4, the sensing center S2 corresponds to a position where the magnetic field generated by the first magnetic element 154g1 is weakest along the Y axis direction. The position P4 is a position where the magnetic flux of the frame body sensor 162g1 in the Y axis direction is zero. Therefore, by placing the sensing center S2 of the frame body sensor 162g1 at the position P4, it may have better sensitivity (better linear working area) to magnetic flux changes.

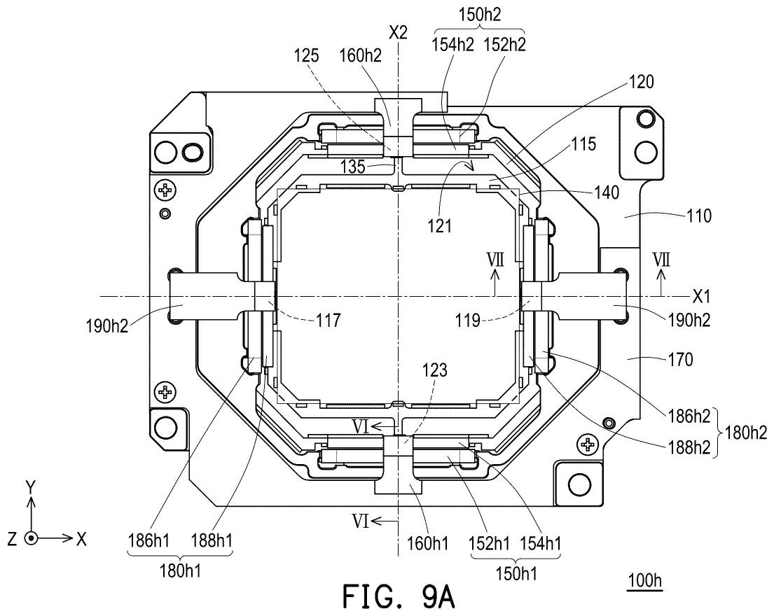

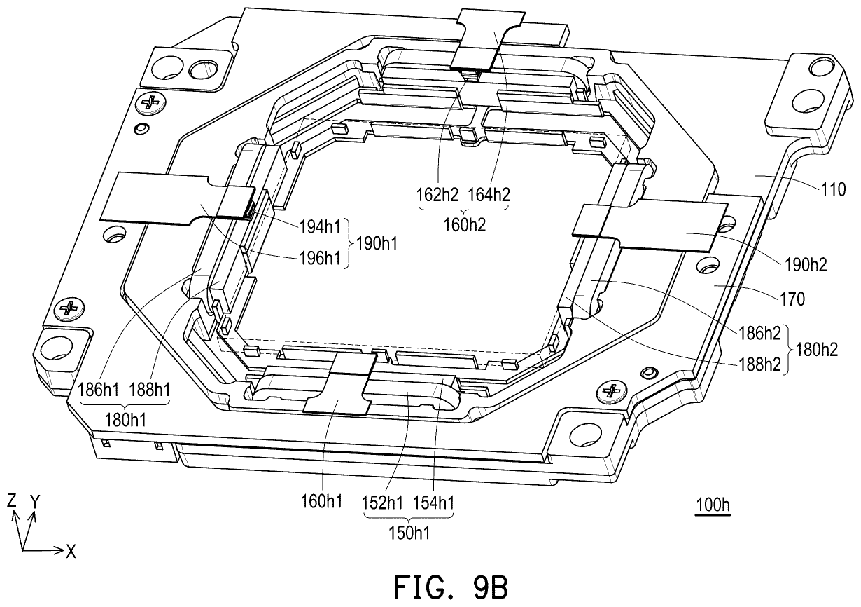

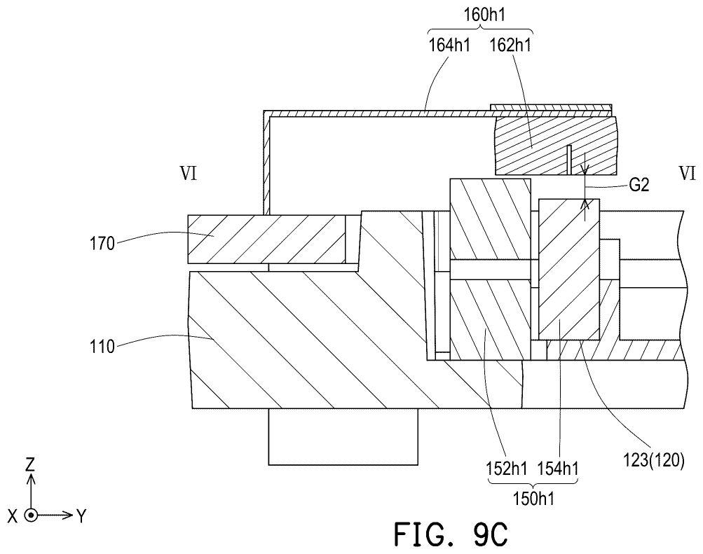

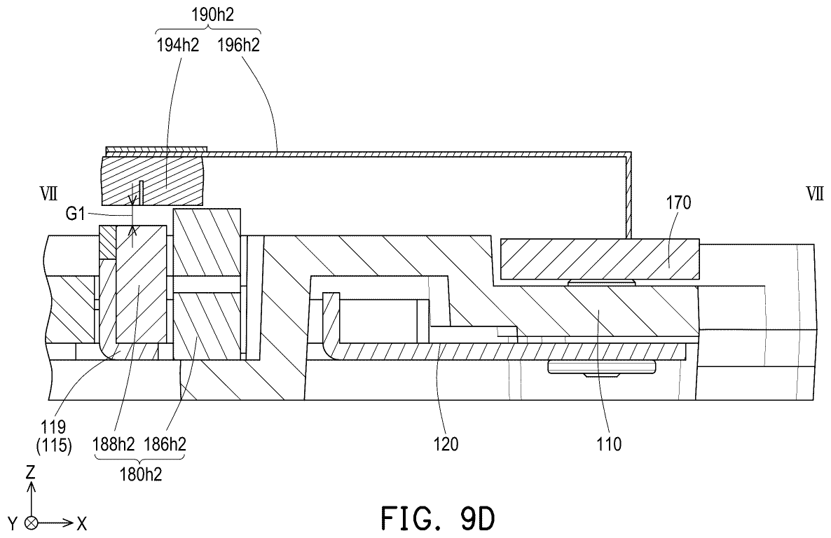

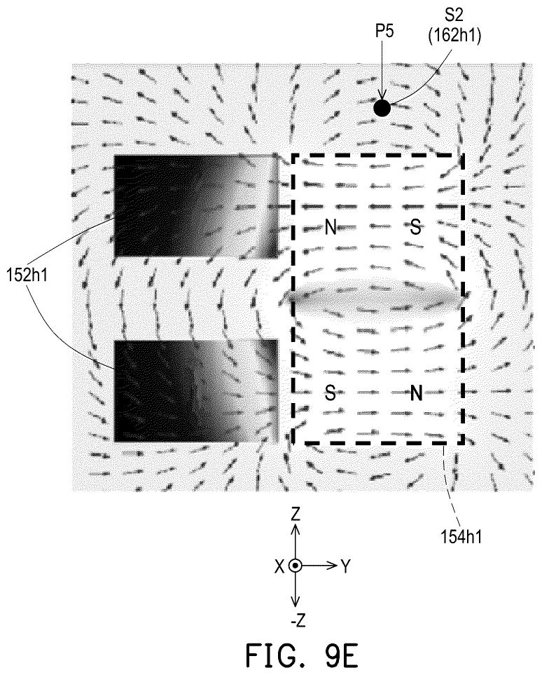

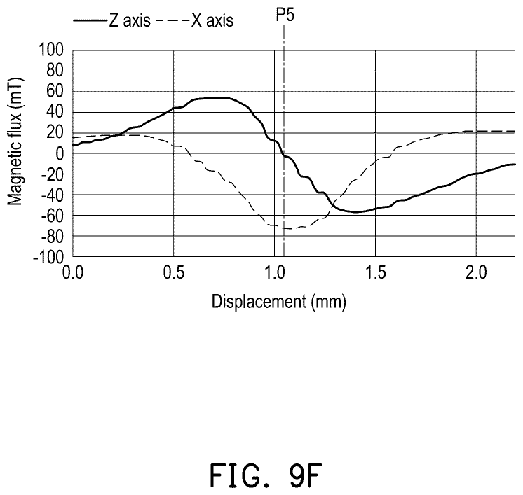

FIG. 9A is a schematic top perspective view of an actuating device according to another embodiment of the disclosure. FIG. 9B is a schematic three-dimensional view of FIG. 9A from another viewing angle. FIG. 9C is a schematic cross-sectional view along a line VI-VI of FIG. 9A. FIG. 9D is a schematic cross-sectional view along a line VII-VII of FIG. 9A. FIG. 9E is a schematic image of magnetic field distribution simulation of a driving assembly and a sensing module of FIG. 9A. FIG. 9F is a schematic curve graph of displacement and magnetic flux of the tested sensing module in FIG. 9E.

Referring to FIG. 6A, FIG. 9A, FIG. 9B, FIG. 9C, and FIG. 9D, an actuating device 100h of the embodiment is similar to the above-mentioned actuating device 100e, and a main difference there between is that in the embodiment, orthogonal projections of the frame portion sensors 194h1 and 194h2 of the frame portion sensing modules 190h1 and 190h2 on the frame portion 115 and orthogonal projections of the second magnetic elements 188h1 and 188h2 of the frame portion driving assemblies 180h1 and 180h2 on the frame portion 115 are partially overlapped, and first gaps G1 are provided between the frame portion sensors 194h1 and 194h2 and the second magnetic elements 188h1 and 188h2. Namely, the second circuit boards 196h1 and 196h2 of the embodiment are respectively fixed on the base 110, and the frame portion sensors 194h1 and 194h2 are respectively fixed on the second circuit boards 196h1 and 196h2 and located above the second magnetic elements 188h1 and 188h2 to detect magnetic flux changes of the second magnetic elements 188h1 and 188h2 moving up and down (swing back and forth with the second axis X2 as the actuation axis).

Furthermore, orthogonal projections of the frame body sensors 162h1 and 162h2 of the frame body sensing modules 160h1 and 160h2 on the frame body 120 and orthogonal projections of the first magnetic elements 154h1 and 154h2 of the frame body driving assemblies 150h1 and 150h2 on the frame body 120 are partially overlapped, and second gaps G2 are provided between the frame body sensors 162h1 and 162h2 and the first magnetic elements 154h1 and 154h2. Namely, the first circuit boards 164h1 and 164h2 of the embodiment are respectively fixed on the base 110, and the frame body sensors 162h1 and 162h2 are respectively fixed on the first circuit boards 164h1 and 164h2 and are located above the first magnetic elements 154g1 and 154g2 to detect magnetic flux changes of the first magnetic elements 154h1 and 154h2 moving up and down (swing back and forth with the first axis X1 as the actuation axis).

Referring to FIG. 9E and FIG. 9F together, FIG. 9E is a schematic image of magnetic field distribution simulation of the sensing module of FIG. 9C. A position P5 represents a configurable position of the sensing center of the sensor (such as the frame body sensor 162h1), where the magnetic element (such as the first magnetic element 154h1) operates relative to the coil (such as the first coil 152h1) and the sensor on the Z-axis, and the magnetic element and the coil are arranged in the Y axis direction. The first coil 152h1, the first magnetic element 154h1 and the frame sensor 162h1 are used as an example for description. When the first magnetic element 154h1 moves up and down along the Z axis (it should be noted that it may move along the Z and −Z axes, or swing back and forth with the first axis X as the actuation axis), a variation amount of the frame body sensor 162h1 corresponding to the Z axis may be measured. The position P5 corresponds to the position where the magnetic lines of force of the first magnetic element 154h1 are horizontal, which means that when the sensing center S2 of the frame body sensor 162h1 is positioned at the position P5, the sensing center S2 corresponds to a position where the magnetic field generated by the first magnetic element 154h1 is weakest along the Z axis direction. The position P5 is a position where the magnetic flux of the frame sensor 162h1 in the Z axis direction is zero, so that by placing the sensing center S2 of the frame body sensor 162h1 at the position P5, it may have better sensitivity (better linear working area) to magnetic flux changes.

In summary, the embodiments of the disclosure have at least one of following advantages or effects. In the design of the actuating device of the disclosure, the frame body driving assembly includes the first coil and the first magnetic element, and the frame body sensor of the frame body sensing module is disposed adjacent to the first magnetic element to sense the amount of change in magnetic field strength of the first magnetic element. Namely, the frame body sensor may sense the amount of change in magnetic field strength of the first magnetic element of the frame body driving assembly, and feed back a signal corresponding to the amount of change in magnetic field strength to the controller, indirectly monitor an image pixel displacement, and adjust the digital waveform and gain data (GAIN) accordingly, so as to optimize the displacement of pixel shift (such as reducing error/variation amount) by using a control method of a closed loop system. Compared with the prior art that senses additionally configured magnets, the frame body sensor of the disclosure directly senses the amount of change in magnetic field strength of the first magnetic element of the frame body driving assembly, so that additional configuration of the magnets is not required, which may effectively save a space. The projector using the actuating device of the disclosure may improve a resolution of a projected image.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variation amounts will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the present disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variation amounts may be made in the embodiments described by persons skilled in the art without departing from the scope of the present disclosure as defined by the following claims. Moreover, no element and component in the present disclosure is intended to be dedicated to the public regardless of whether the element or component is explicitly recited in the following claims.

What is claimed is:

1. An actuating device, configured to receive an image beam, the actuating device comprising a base, a frame body, two first shaft portions, an optical element, a frame body driving assembly, and a frame body sensing module, wherein
the frame body is swingably connected to the base,
the frame body comprises an opening, the opening is located between the two first shaft portions, the two first shaft portions extend along a first axis and are respectively connected to two opposite sides of the frame body, and each of the two first shaft portions is located between the frame body and the base, wherein the frame body further has two first side walls located on a second axis and opposite to each other, and the first axis is perpendicular to the second axis,
the optical element is disposed in the opening of the frame body,
the frame body driving assembly is configured to drive the frame body to swing about the two first shaft portions as rotating axes, so that the frame body drives the optical element to swing back and forth relative to the base,
the frame body driving assembly comprises a first coil and a first magnetic element, the first magnetic element is disposed on one of the two first side walls of the frame body and is located between the first coil and the frame body, and the first coil corresponds to the first magnetic element and is disposed on the base, and
the frame body sensing module is connected to the base and comprises a frame body sensor, the frame body sensor is disposed adjacent to the first magnetic element to sense an amount of change in magnetic field strength of the first magnetic element.

2. The actuating device according to claim 1, further comprising another frame body driving assembly and another frame body sensing module, wherein the another first magnetic element of the another frame body driving assembly is disposed on another one of the two first side walls, and the another frame body sensor of the another frame body sensing module is disposed adjacent to the another first magnetic element.

3. The actuating device according to claim 1, wherein the first coil comprises two first coil portions connected in series, and the frame body sensor is located between the two first coil portions.

4. The actuating device according to claim 1, wherein along the second axis, the first magnetic element is located between the frame body sensor and the first coil.

5. The actuating device according to claim 1, wherein in a direction parallel to the first axis, a first length of the first coil is smaller than a second length of the first magnetic element, and the frame body sensor and the first coil are sequentially arranged in the direction parallel to the first axis, and the frame body sensor is located on one side of the first coil.

6. The actuating device according to claim 1, wherein the frame sensing module comprises a first circuit board, the first circuit board is fixed on the base, and the frame body sensor is fixed on the first circuit board.

7. The actuating device according to claim 1, wherein the frame body sensor has a sensing center, and the sensing center is located at a position where a magnetic flux of the first magnetic element is zero.

8. The actuating device according to claim 1, further comprising a frame portion and two second shaft portions, wherein the frame portion has a hollow structure and is disposed in the opening of the frame body, the optical element is disposed in the hollow structure of the frame portion, the frame portion has two second side walls located on the first axis and opposite to each other, the two second shaft portions extend along the second axis and are respectively connected to two opposite sides of the frame portion, and the two second shaft portions are respectively located between the frame portion and the two first side walls of the frame body.

9. The actuating device according to claim 8, further comprising a frame portion driving assembly and a frame portion sensing module, wherein the frame portion driving assembly comprises a second coil and a second magnetic element, the second magnetic element is disposed on one of the two second side walls of the frame portion and is located between the second coil and the frame portion, the second coil corresponds to the second magnetic element and is disposed on the base, the frame portion sensing module is connected to the base and comprises a frame portion sensor, and the frame portion sensor is disposed adjacent to the second magnetic element to sense an amount of change in magnetic field strength of the second magnetic element.

10. The actuating device according to claim 9, further comprising another frame body driving assembly and another frame body sensing module, wherein the another first magnetic element of the another frame body driving assembly is disposed on another one of the two first side walls, and the another frame body sensor of the another frame body sensing module is disposed adjacent to the another first magnetic element.

11. The actuating device according to claim 10, further comprising another frame portion driving assembly and another frame portion sensing module, wherein the another second magnetic element of the another frame portion driving assembly is disposed on another one of the two second side walls, and the another frame portion sensor of the another frame portion sensing module is disposed adjacent to the another second magnetic elements.

12. The actuating device according to claim 9, wherein the first coil comprises two first coil portions connected in series, the frame body sensor is located between the two first coil portions, the second coil comprises two second coil portions connected in series, and the frame portion sensor is located between the two second coil portions.

13. The actuating device according to claim 9, wherein on the second axis, the first magnetic element is located between the frame body sensor and the first coil, and on the first axis, the second magnetic element is located between the frame portion sensor and the second coil.

14. The actuating device according to claim 9, wherein in a direction parallel to the first axis, a first length of the first coil is smaller than a second length of the first magnetic element, the frame body sensor and the first coil are sequentially arranged in the direction parallel to the first axis, the frame body sensor is located on one side of the first coil, in the direction parallel to the second axis, a third length of the second coil is smaller than a fourth length of the second magnetic element, the frame portion sensor and the second coil are sequentially arranged in the direction parallel to the second axis, and the frame portion sensor is located at one side of the second coil.

15. The actuating device according to claim 9, wherein the frame portion sensing module comprises a second circuit board, the second circuit board is fixed on the base, and the frame portion sensor is fixed on the second circuit board.

16. The actuating device according to claim 9, wherein the frame body sensor has a sensing center, the sensing center is located at a position where a magnetic flux of the first magnetic element is zero, the frame portion sensor has a sensing center, and the sensing center is located at a position where a magnetic flux of the second magnetic element is zero.

17. The actuating device according to claim 9, wherein the first coil has a first opening, the second coil has a second opening, the frame body sensor is disposed in the first opening, and the frame portion sensor is disposed in the second opening.

18. The actuating device according to claim 9, wherein an orthogonal projection of the frame portion sensor on the frame portion partially overlaps an orthogonal projection of the second magnetic element on the frame portion, a first gap is provided between the frame portion sensor and the second magnetic element, an orthogonal projection of the frame body sensor on the frame body partially overlaps an orthogonal projection of the first magnetic element on the frame body, and a second gap is provided between the frame body sensor and the first magnetic element.

19. A projector, comprising an illumination system, a light valve, a projection lens, and an actuating device, wherein
the illumination system is configured to provide an illumination beam,
the light valve is configured to convert the illumination beam into an image beam;
the projection lens is configured to project the image beam out of the projector, and
the actuating device is disposed between the light valve and the projection lens to receive the image beam, the actuating device comprises a base, a frame body, two first shaft portions, an optical element, a frame body driving assembly, and a frame body sensing module, wherein
the frame body is swingably connected to the base,
the frame body comprises an opening, the opening is located between the two first shaft portions, the two first shaft portions extend along a first axis and are respectively connected to two opposite sides of the frame body, and each of the two first shaft portions is located between the frame body and the base, wherein the frame body further has two first side walls located on a second axis and opposite to each other, and the first axis is perpendicular to the second axis,
the optical element is disposed in the opening of the frame body,
the frame body driving assembly is configured to drive the frame body to swing about the two first shaft portions as rotating axes, so that the frame body drives the optical element to swing back and forth relative to the base, wherein the frame body driving assembly comprises a first coil and a first magnetic element, the first magnetic element is disposed on one of the two first side walls of the frame body and is located between the first coil and the frame body, and the first coil corresponds to the first magnetic element and is disposed on the base, and
the frame body sensing module is connected to the base and comprises a frame body sensor, and the frame body sensor is disposed adjacent to the first magnetic element to sense an amount of change in magnetic field strength of the first magnetic element.
